(19) United States
(12) Patent Application Publication
(10) Pub. No.: US 2010/0129046 A1
(43) Pub. Date: May 27, 2010

(54) METHOD AND APPARATUS FOR RECORDING AND PLAYBACK PROCESSES

(76) Inventor: Pertti Tolonen, Vantaa (FI)

Correspondence Address: DITTHAVONG MORI & STEINER, P.C., 918 Prince Street, Alexandria, VA, 22314, US

(21) Appl. No.: 12/275,337

(22) Filed: Nov. 21, 2008

(51) Int. Cl. H04N 5/93

(52) U.S. Cl. 386/52; 386/E05.028

(57) ABSTRACT

A system for receiving information for recording may receive sensor information in an apparatus, and control data may be determined based on the sensor information. One or more instances of control data may be integrated with the corresponding instance of recorded information, and the integrated information may be stored. The system may further comprise activating an integrated information playback process in an apparatus, the integrated information comprising recorded information and control data. One or more instances of the control data may be processed, and the recorded information may be played back in a particular playback mode. The particular playback mode at one or more instances of the recorded information may be determined in accordance with the processed control data occurring at the same instance.

### BACKGROUND

1. Field of Invention

Example embodiments relate to information for recording, and for example, to a method and/or apparatus for performing a recording and/or a playback process.

2. Background

The number of inexpensive devices for recording sports exercise data (e.g., position, speed, heart rate, etc.) continues to increase. Conventional web services allow mobile device users to record GPS-location based exercise data and upload the recorded textual and/or numeric data as exercise logs to the web service. The users may use the web service for reviewing the uploaded exercises or sharing the uploaded exercise logs with friends or a public audience.

Audio/video recording of exercises or performances has become particularly popular in “extreme” sports, (e.g., mountain biking, skateboarding, etc.). Sport participants record exercises as audio/video recordings and share the recordings among friends and on the internet. For example, a video camera may be mounted on a bike or helmet of the user to record the user's view during the sporting activity.

However, an unedited recording of a sport or exercise may have a relatively long duration including some portions that may be uninteresting to a viewer. As a result, the viewer needs to watch the uninteresting real-time playback or control the playback manually in order to view the more interesting portions of the recording. For example, the viewer needs to manually edit the video to remove the uninteresting portions or control the playback manually, (e.g., with a fast-forward function), to omit the uninteresting portions.

Conventional effects used in multi-track audio and video editing software products do not modify the original audio/video material, instead, the user merely manually selects and fine tunes the effects, (e.g., volume control, playback speed, sharpening filter, brightness, etc.) being applied.

### SUMMARY

Example embodiments may provide a method, apparatus and/or computer program product configured to perform a recording process and/or a playback process in an apparatus.

According to an example embodiment, a method may receiving information for recording. Sensor information may be received in the apparatus, and control data may be determined based on the sensor information and/or the recorded information. One or more instances of control data may be integrated with the corresponding instance of recorded information, and the integrated information may be stored.

According to an example embodiment, a method may include activating an integrated information playback process in an apparatus, the integrated information comprising recorded information and control data. One or more instances of the control data may be processed, and the recorded information may be played back in a particular playback mode. The particular playback mode at one or more instances of the recorded information may be determined in accordance with the processed control data occurring at the same instance.

According to an example embodiment, an apparatus may include a processor and/or a memory. The processor may be configured to receive information for recording and sensor information. The processor may be configured to determine control data based on the sensor information and/or the recorded information and integrate one or more instances of control data with the corresponding instance of recorded information. The memory may be configured to store the integrated information.

According to an example embodiment, an apparatus may include a processor. The processor may be configured to activate an integrated information playback process, the integrated information comprising recorded information and control data. The processor may be configured to process one or more instances of the control data and play back the recorded information in a particular playback mode. The particular playback mode at one or more instances of the recorded information may be determined in accordance with the processed control data occurring at the same instance.

According to an example embodiment, a computer program product comprising a computer readable medium having computer readable program code embodied in said medium for managing information may include a computer readable program code configured to receive information for recording, a computer readable program code configured to receive sensor information in the apparatus, a computer readable program code configured to determine control data based on the sensor information and/or the recorded information, a computer readable program code configured to integrate one or more instances of control data with the corresponding instance of recorded information, and/or a computer readable program code configured to store the integrated information.

According to an example embodiment, a computer program product comprising a computer readable medium having computer readable program code embodied in said medium for managing information may include a computer readable program code configured to activate an integrated information playback process in an apparatus, the integrated information comprising recorded information and control data, a computer readable program code configured to process one or more instances of the control data, and/or a computer readable program code configured to play back the recorded information in a particular playback mode. The particular playback mode at one or more instances of the recorded information may be determined in accordance with the processed control data occurring at the same instance.

The above summarized configurations or operations of various embodiments of the present invention have been provided merely for the sake of explanation, and therefore, are not intended to be limiting. Moreover, inventive elements associated herein with a particular example embodiment of the present invention can be used interchangeably with other example embodiments depending, for example, on the manner in which an embodiment is implemented.

### DESCRIPTION OF DRAWINGS

Example embodiments will be further understood from the following detailed description of various embodiments taken in conjunction with appended drawings, in which:

FIG. 1 illustrates an audio/video system according to an example embodiment;

FIG. 2 illustrates example information including video, audio, altitude, speed, heading, and heart rate data received during a recording process according to an example embodiment;

FIG. 3 illustrates an extraction of an example playback control channel from control data based on sensor information according to an example embodiment;

FIG. 4 illustrates another example playback control channel applied to recorded audio/video data according to an example embodiment;

FIG. 5 illustrates examples of graphical and/or textual information that may be displayed during playback according to an example embodiment; and

FIG. 6 is a flow chart illustrating a method according to an example embodiment; and

FIG. 7 is a flow chart illustrating a method according to another example embodiment.

### DESCRIPTION OF EXAMPLE EMBODIMENTS

Reference will now be made to example embodiments, which are illustrated in the accompanying drawings, wherein like reference numerals refer to the like components throughout.

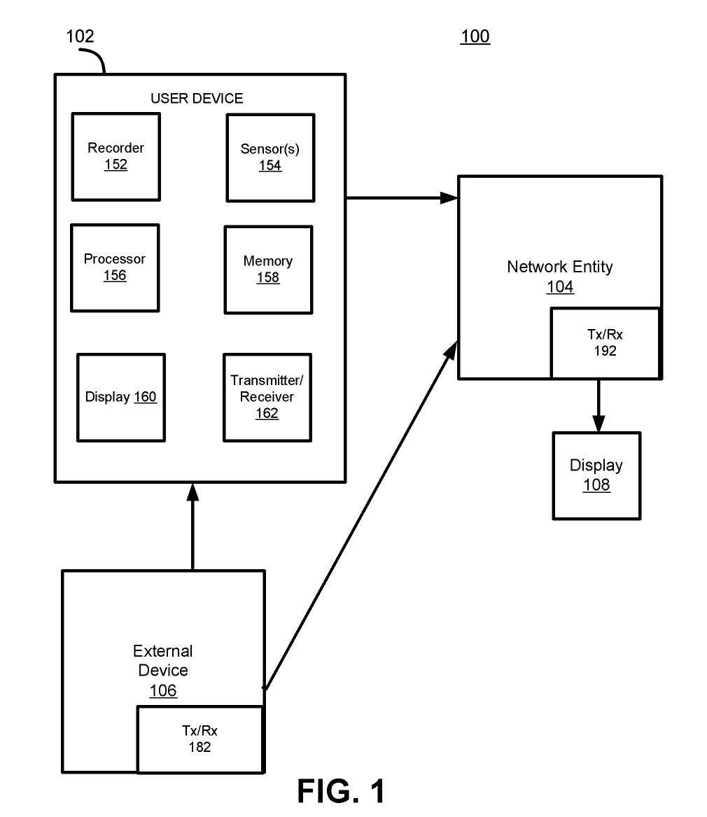

A user may receive information for recording and/or sensor information, for example, the user may receive and/or record audio/video data during exercise or a sporting activity and simultaneously receive and/or record sensor information for determining control data at the same time. FIG. 1 illustrates a system according to an example embodiment. The system 100 may include a user device 102, a network entity 104, and/or one or more devices 106 which are external to the user device 102 and the network entity 104. The user device 102 may include a recorder 152, one or more sensors 154, a processor 156, a memory 158, a display 160, and/or a transmitter/receiver 162. The network entity 104 may be a server, other user device, network access point (AP) or station (STA), communications device, PDA, cell phone, mobile terminal, mobile computer, laptop or palmtop computer, or any other apparatus and include a transmitter/receiver 192. The external device 106 may include a transmitter/receiver 182. Accordingly, data may be exchanged between each of the user device 102, external device 106, and/or network entity 104 in the system 100 according to example embodiments.

The user device 102 may be various devices configured to receive and/or record audio/video data and/or sensor information. For example, the user device 102 may be a communications device, PDA, cell phone, mobile terminal, mobile computer, laptop or palmtop computer, or any other apparatus. The user device 102 may include a control module which includes the processor 156 and the memory 158 including a random access memory (RAM) and/or a read only memory (ROM). The user device 102 may include interface circuits (e.g., wired and/or wireless buses) to interface with the transmitter/receiver 162, battery and other power sources, key pad, touch screen, display, microphone, speakers, ear pieces, sensors, camera or other imaging devices, etc. in the user device 102. The processor 156 may comprise one or more of a complex logic module, an ASIC, or an instruction processor. The RAM and ROM may comprise fixed components and/or removable memory devices, e.g., smart cards, subscriber identification modules (SIMs), wireless identity modules (WIMs), semiconductor memories, (e.g., RAM, ROM, programmable read only memory (PROM), flash memory devices), etc. The user device 102 may further act as a station (STA) or as access point (AP) in a WLAN network or in any other ad hoc wireless networking.

The external devices 106 may be other user devices 102 or external sensors. For example, the external devices 106 may include or be various sensors, (e.g., heart rate sensor, odometer, compass, barometer, accelerometer, altimeter, etc.), a communications device, PDA, cell phone, mobile terminal, laptop or palmtop computer, or any other apparatus. If an external device 106 is another user device 102, the external device may comprise elements the same as or similar to the elements discussed in regard to the user device 102 and in FIG. 1, (e.g., a processor, memory, etc.), and therefore, a description thereof is omitted. The user device 102 may be a central hub for the one or more external devices 106, and the external devices 106 may upload data to the user device 102. According to another example embodiment, the external devices 106 and/or the user device 102 may provide data to the network entity 104. For example, the external devices 106 may buffer and/or pre-process the sensor information and/or information for recording and provide the data to the network entity 104 in real-time, (.e.g., during recording of the information), or from a local memory after recording has occurring. The external devices 106 may convey data to the user device 102 and/or the network entity 104 through wired or wireless connections. Alternatively, there may be no external devices 106, e.g., there may be no sensors external to the user device 102.

The recorder 152 and/or the processor 156 may be configured to activate a recording process in the user device 102 and receive information, e.g., audio/video data, for recording. For example, the user device 102 records audio/video data using the recorder 152 and/or receives audio/video data from external devices 106. The one or more sensors 154 may be configured to receive sensor information. For example, the user device 102 records sensor information using the sensor 154 and/or receives sensor information from external devices 106. The one or more sensors 154 may be or include various sensors, (e.g., heart rate sensor, odometer, compass, barometer, accelerometer, altimeter, etc.), various data recording devices, or any other apparatus. Control data may be determined from the sensor information, and each instance of control data may correspond in time to an instance of the information for recording, e.g., the audio/video data. The sensor information, control data, and audio/video data may include a timestamp or another temporal indicator for determining each instance.

In another example embodiment, the information for recording and the sensor information in a plurality of devices is concatenated together. For example, a group of cyclists includes a member having a device configured to record a video of the biking session and other members of the group having devices configured to record heart rate and location information, respectively. After the biking session, the video recording, which includes location information to enable mapping of the data, is provided to the other cyclists. The first other cyclist recording heart rate information creates and applies control data based on the heart rate information to the video recording and the second other cyclist creates and applies control data based on the location information to the video recording. Alternatively, the first and second cyclists exchange sensor information such that the control data for each of the other cyclists is based on each of the others sensor information. Accordingly, each of the other cyclists respectively creates an edited version of the video recording based on the corresponding sensor information, e.g., based on an integration process with the control data or a playback control channel based on the control data.

In still another example embodiment, a plurality of members of a group have devices configured to record the information for recording, e.g., audio/video data, and the audio/video data recordings are provided to the members such that at least one of the members, e.g., a member having a user device 102 acting as a central hub, has two or more audio/video recordings for the same instance or period. The information for recording may include information on the device on which the recording was recorded. The user device 102 acting as the central hub creates control data based on sensor information recorded locally and/or received from one or more of the other devices in the group. Accordingly, a plurality of different recording information for the same instance or period may be received, and which of the recording information is played back at a particular instance may be determined based on the control data, e.g., based on an integration process with the control data or a playback control channel based on the control data.

The sensor information may include various types of data indicative of a user's condition or surroundings or a state of a device. For example, the sensor information may comprise one or more of location data, altitude data, velocity data, acceleration data, heading data, weather condition data, visibility data, heart rate data, etc. The sensor information may be recorded and/or received by the one or more sensors 154 in the user device 102 and/or by one or more external devices 106. If external devices 106 record audio/video data or sensor information, the audio/video data and/or the sensor information may be transmitted to the user device 102 acting as a central hub. According to another example embodiment, the external devices 106 may upload the audio/video data and/or the sensor information to the network entity 104.

The user device 102 may store the information for recording, (e.g., audio/video data), the sensor information from the one or more sensors 154 and/or any audio/video data and/or sensor information provided by external devices 106 in the memory 108. According to another example embodiment, the audio/video data and/or sensor information recorded by the user device 102 and audio/video data and/or sensor information recorded by each of the external devices 106 may be stored separately in the respective devices. The network entity 104 may store audio/video data and/or sensor information received from the user device 102 and/or the external devices 106. The sensor information may be stored separately from the information for recording in the same device or in different devices.

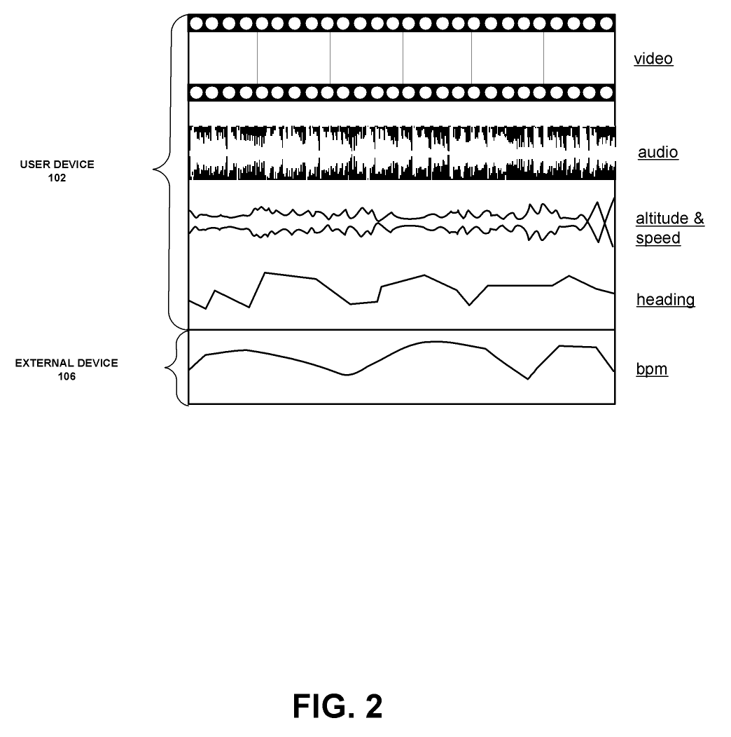

FIG. 2 illustrates an example of recorded information including video, audio, altitude, speed, heading, and heart rate data received according to an example embodiment. For example, as shown in FIG. 2, the video, audio, altitude and speed, and heading data is recorded by the user device 102 and an external device 106 records the heart rate data in beats per minute (bpm) during an activity performed by a user. However, example embodiments are not limited thereto, and data may be collected by various other combinations of devices and may include various other types of data. The external device 106 uploads the heart rate data to the user device 106 and/or to the network entity 104. The audio/video data and the altitude and speed data, heading data, and heart rate data may be uploaded to the network entity 104 and/or stored in the user device 102.

After the information for recording and sensor information is received in the user device 102 and/or external devices 106, processing of the information for recording, (e.g., audio/video data), and the sensor information may occur. The processing of the audio/video data and the sensor information may occur in the user device 102, or alternatively, in the network entity 104 if the recorded information and sensor information has been provided to the network entity 104. The control data may be determined from the sensor information. For example, the control data may include some or all of the raw (unprocessed) sensor information, or alternatively, a processed version of the sensor information. Processing of the recorded information and the sensor information may include integrating one or more instances of control data with the corresponding instance of recorded information. For example, an instance of control data recorded at the same time as an instance of audio/video data, (e.g., having the same time stamp), may be integrated with the corresponding audio/video data. For example, referring again to FIG. 2, control data may be derived from measurements of altitude and speed, heading, and/or heart rate. If there is more than one audio/video recording for the same instance, the control data may be used to determine from which recording the instance of audio/video data is selected. One or more instances of the control data determined from the altitude and speed data, heading data, and heart rate data may be integrated with the corresponding instance of audio/video data. The integrated information may be stored in the user device 102 or network entity 104.

The control data may be processed to extract a playback control channel from the control data. For example, the playback control channel may be extracted by applying a desired, or alternatively, a predetermined process to the control data. Accordingly, the control data may be used to determine various playback modes for the recorded information. The playback control channel may determine a playback mode for one or more instances of the recorded information. For example, the particular playback mode at one or more instances of the recorded information may be determined in accordance with the processed control data at the same instance. The playback mode may control the manner in which each of the one or more instances is presented during playback. For example, the mode determined from the playback control channel determines playback during a particular instance may be omitted, a playback rate for the instance of recorded information, a number of times a portion of the recorded information including the instance should be consecutively played back, and/or various other options for playing back recorded information. If there is more than one audio/video recording for the same instance, the playback control channel may be used to determine from which recording the instance of audio/video data is selected. Accordingly, the user device 102 or the network entity 104 plays back the recorded information in a particular playback mode, and the result thereof may be displayed on the display 160 in the user device 102 or on display 108 connected to the network entity 104 if the recorded information includes video data.

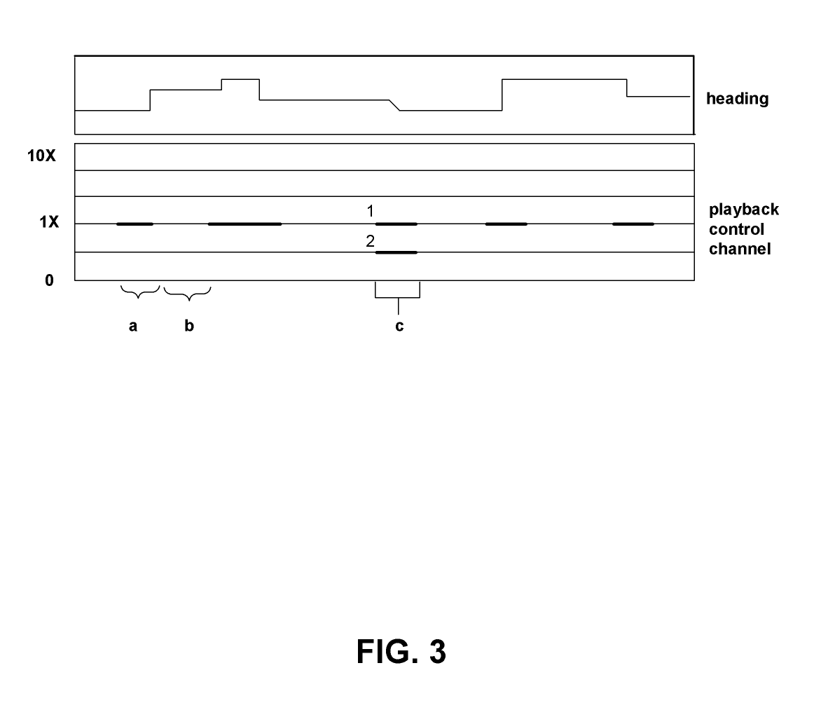

FIG. 3 illustrates an extraction of an example playback control channel from sensor information according to another example embodiment. The example playback control channel illustrated in FIG. 3 is extracted from a variation of the heading information, (e.g., direction of movement information), in the control data. However, example embodiments are not limited thereto, and the playback control channel may be based one or more various other types of information included in the control data. In the example of FIG. 3, for each portion of the audio/video recording corresponding to a portion of the playback control channel representing a change in heading violating a threshold level, the portion of the audio/video recording will be played back in real time. For example, section “a” in FIG. 3 shows a portion of the playback control channel which will present the corresponding audio/video recording in real time. For each portion of the audio/video recording corresponding to a portion of the playback control channel representing no change in heading, the portion of the audio/video recording will not be played back, e.g., the portion will be skipped. For example, section “b” in FIG. 3 shows a portion of the playback control channel which will skip the corresponding portion of the audio/video recording. Section “c” in FIG. 3 shows a portion of the playback control channel which will repeat a portion of the audio/video recording, e.g., to create an instant replay effect. Accordingly, the playback control channel is determined based on various desired, or alternatively, predetermined processes configured to extract the playback control channel from the control data based on the sensor information, and a playback mode is set for one or more instances of the recorded information.

The recorded information, the sensor information, the control data, and/or the playback control channel may be stored in the network entity 104 or user device 102, and playback may be produced based on the recorded information, the sensor information, the control data and/or the playback control channel during playback time, e.g., to provide more flexibility for tuning the playback. The playback control channel may be stored separately from the recorded information. For example, the recorded information and the sensor information may be processed during playback and/or the playback control channel may be applied to the recorded information during playback. Alternatively, the recorded information may be pre-processed with the playback control channel and the result stored in the network entity 104 or user device 102, e.g., to improve the playback performance. If the processed version of the recorded information (e.g., including the playback control channel) is stored in the network entity 104 or user device 102, the result may be played back without additional processing. For example, at least a video playback version of the recorded information that has been previously defined by the playback control channel may be readily available for consumption.

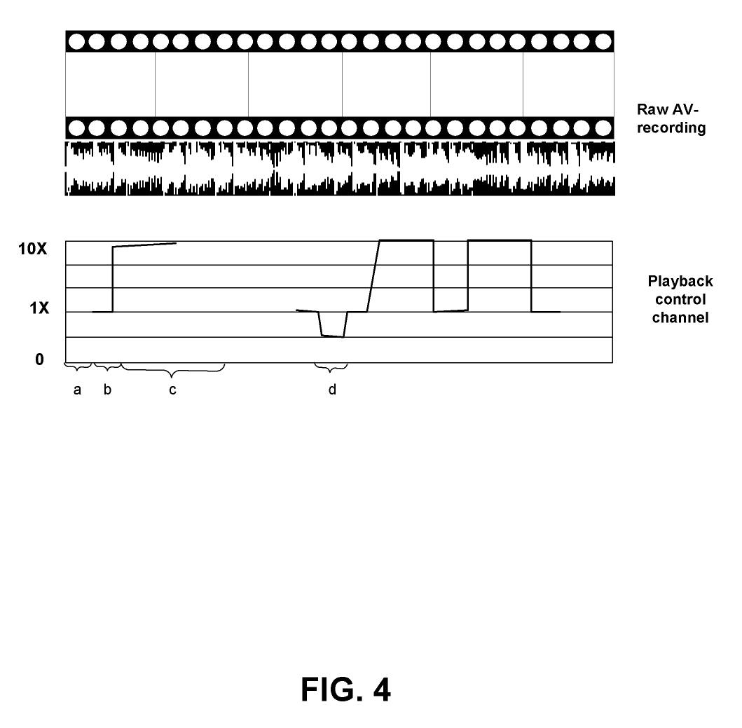

FIG. 4 illustrates another example playback control channel as applied to recorded audio/video data according to an example embodiment. The upper portion of FIG. 4 illustrates the audio and video channels of the original recorded information and the bottom portion of FIG. 4 illustrates the example playback control channel. Referring to FIG. 4, according to the playback mode determined by the playback control channel for each instance of the recorded information, section “a” of the audio/video recording will not be played back, (e.g., skipped), section “b” of the audio/video recording will be played back at a normal speed, section “c” will be played back at 10 times the normal speed, and section “d” will be played back at half of the normal speed, (e.g., in slow-motion). Accordingly, each instance or portion of the recorded information is played back in a particular playback mode determined in accordance with the processed control data, e.g., the playback control channel, occurring at the same instance or portion.

In another example embodiment, the playback control channel is continuously created during playback as new sensor information and/or audio/video information is received. For example, a user device 102 for a jogger is configured to play back music tracks and record heart rate information. The user device 102 creates a playback control channel based on the heart rate information such that a current music track being listened to by the jogger is played back in a playback mode based on the jogger's current heart rate. If the heart rate of the jogger violates one or more desired, or alternatively, predetermined thresholds the music playback is changed, e.g., sped up, slowed down, or made a different music track. For example, if the user's heart rate is too high, the playback control channel based on the heart rate of the jogger is adapted in real time to increase the play rate of the music track. Alternatively, if the user's heart rate is too low, the playback control channel is adapted in real time to decrease the play rate of the music track. The playback control channel and/or a result of the playback control channel applied to the music track may be stored in the memory 158 or in the network entity 104. Accordingly, the jogger may “listen” to how well he or she managed to perform within the limits set by the thresholds, e.g., by taking a percentage differentiation from the original beats per minute of the music track.

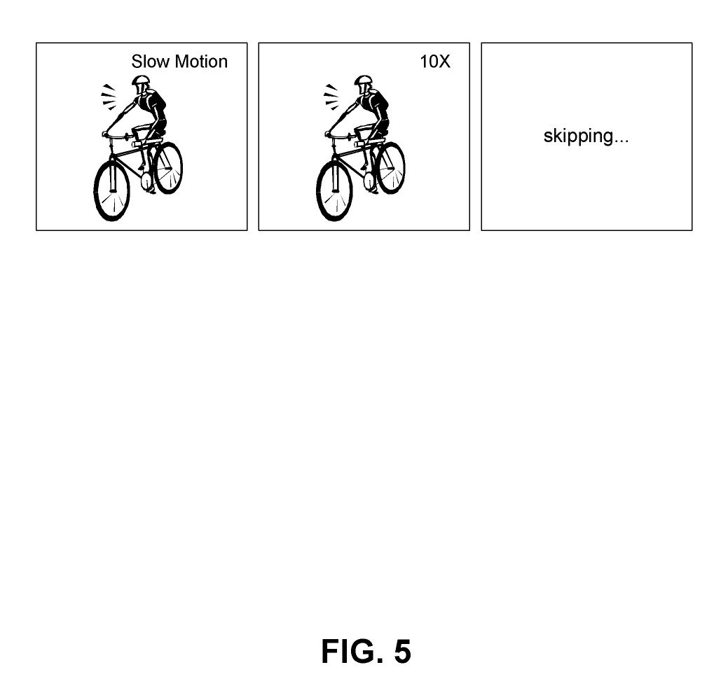

During playback, graphical and/or textual information including information about the type of playback mode used for each instance or portion of the recorded information being played back may be displayed. FIG. 5 illustrates examples of graphical and/or textual information that may be displayed during playback. For example, during playback an indicator may be displayed indicating if the recorded information is being played back in real-time, slow-motion, fast-forward, etc. An indicator may be displayed during playback to indicate that an instance or portion of the recorded information is being skipped. However, example embodiments are not limited thereto, and graphical and/or textual information indicating any feature of the playback mode may be displayed. As illustrated in FIG. 5, graphical and/or textual information is displayed during playback to illustrate “slow motion” for a reduced playback rate, “10×” for an increased playback rate, and “skipping” to indicate that an instance or portion of recorded information is being skipped.

The playback control channel may be further based on user input data. For example, user input data may be included with the control data processed to create the playback and/or the playback control channel may be altered based on user input data after the control data is processed to create the playback control channel. Accordingly, a user edits the playback control channel to fine tune the content of the final playback. User input data may be used to edit playback during playback. For example, a user watching the playback of recorded information as defined by the playback control channel manually controls the playback independently of or building on top of the playback control channel data. Accordingly, the user, for example, plays back portions of the recorded information not originally included by the playback control channel or select a different playback speed than is defined by the playback control channel, etc.

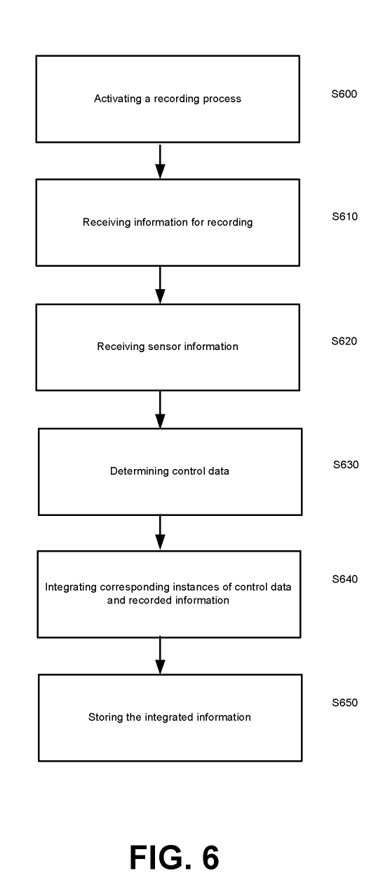

FIG. 6 is a flow chart illustrating a method according to an example embodiment. Referring to FIG. 6, at step S600, a recording process may be activated in an apparatus. At step S610 information for recording may be received. Sensor information may be received in the apparatus at step S620, and control data may be determined based on the sensor information at step S630. At step S640, each instance of control data may be integrated with the corresponding instance of recorded information, and the integrated information may be stored at step S650.

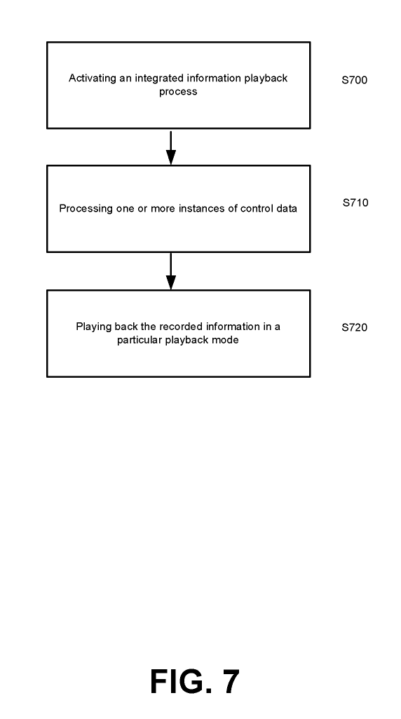

FIG. 7 is a flow chart illustrating a method according to another example embodiment. Referring to FIG. 7, at step S700 an integrated information playback process may be activated in an apparatus. The integrated information may include recorded information and control data. At step S710, each instance of the control data may be processed. The recorded information may be played back in a particular playback mode at step S720. The particular playback mode at each instance of the recorded information may be determined in accordance with the processed control data occurring at the same instance.

Although example embodiments have been shown and described in this specification and figures, it would be appreciated by those skilled in the art that changes may be made to the illustrated and/or described example embodiments without departing from their principles and spirit.

What is claimed is:

1. A method, comprising:
receiving information for recording;
receiving sensor information in the apparatus;
determining control data based on the sensor information;
integrating one or more instances of control data with the corresponding instance of recorded information; and
storing the integrated information.

2. The method of claim 1, wherein the sensor information comprises one or more of location data, altitude data, velocity data, acceleration data, heading data, weather data, visibility data, and heart rate data.

3. The method of claim 1, wherein at least a portion of the sensor information is received from one or more external devices.

4. A method, comprising:
activating an integrated information playback process in an apparatus, the integrated information comprising recorded information and control data;
processing one or more instances of the control data; and
playing back the recorded information in a particular playback mode, wherein the particular playback mode at one or more instances of the recorded information is determined in accordance with the processed control data occurring at the same instance.

5. The method of claim 4, wherein the particular playback mode at each of the one or more instances of the recorded information determines if the instance of recorded information is played back.

6. The method of claim 4, wherein the particular playback mode at each of the one or more instances of the recorded information determines a playback rate for the instance of the recorded information.

7. The method of claim 4, wherein the control data is based on one or more of location data, altitude data, velocity data, acceleration data, heading data, weather data, visibility data, and heart rate data.

8. The method of claim 4, wherein the particular playback mode at each of the one or more instances of the recorded information is further determined based on user input.

9. The method of claim 4, wherein playing back the recorded information is further based on user control data received during playback.

10. The method of claim 4, further comprising:
receiving the recorded information and the control data from one or more external devices.

11. An apparatus, comprising:
a processor configured to receive information for recording and sensor information, the processor configured to determine control data based on the sensor information and integrate one or more instances of control data with the corresponding instance of recorded information; and
a memory configured to store the integrated information.

12. The apparatus of claim 11, wherein the sensor information comprises one or more of location data, altitude data, velocity data, acceleration data, heading data, weather data, visibility data, and heart rate data.

13. The apparatus of claim 11, wherein at least a portion of the sensor information is received from one or more external devices.

14. An apparatus, comprising
a processor configured to activate an integrated information playback process, the integrated information comprising recorded information and control data, wherein
the processor is configured to process one or more instances of the control data, and
the processor is configured to play back the recorded information in a particular playback mode, wherein the particular playback mode at one or more instances of the recorded information is determined in accordance with the processed control data occurring at the same instance.

15. The apparatus of claim 14, wherein the particular playback mode at each of the one or more instances of the recorded information determines if the instance of recorded information is played back.

16. The apparatus of claim 14, wherein the particular playback mode at each of the one or more instances of the recorded information determines a playback rate for the instance of the recorded information.

17. The apparatus of claim 14, wherein the control data is based on one or more of location data, altitude data, velocity data, acceleration data, heading data, weather data, visibility data, and heart rate data.

18. The apparatus of claim 14, wherein the particular playback mode at each of the one or more instances of the recorded information is further determined based on user input.

19. The apparatus of claim 14, wherein the playing back the recorded information is further based on user control data received during playback.

20. The apparatus of claim 14, further comprising:
receiving the recorded information and the control data from one or more external devices.

21. A computer program product comprising a computer readable medium having computer readable program code embodied in said medium for managing information, said product comprising:
a computer readable program code configured to receive information for recording;
a computer readable program code configured to receive sensor information in the apparatus;
a computer readable program code configured to determine control data based on the sensor information;
a computer readable program code configured to integrate one or more instances of control data with the corresponding instance of recorded information; and
a computer readable program code configured to store the integrated information.

22. The computer program product of claim 21, wherein the sensor information comprises one or more of location data, altitude data, velocity data, acceleration data, heading data, weather data, visibility data, and heart rate data.

23. The computer program product of claim 21, wherein at least a portion of the sensor information is received from one or more external devices.

24. A computer program product comprising a computer readable medium having computer readable program code embodied in said medium for managing information, said product comprising:
a computer readable program code configured to activate an integrated information playback process in an apparatus, the integrated information comprising recorded information and control data;
a computer readable program code configured to process one or more instances of the control data; and
a computer readable program code configured to play back the recorded information in a particular playback mode, wherein the particular playback mode at one or more instances of the recorded information is determined in accordance with the processed control data occurring at the same instance.

25. The computer program product of claim 24, wherein the particular playback mode at each of the one or more instances of the recorded information determines if the instance of recorded information is played back.

26. The computer program product of claim 24, wherein the particular playback mode at each of the one or more instances of the recorded information determines a playback rate for the instance of the recorded information.

27. The computer program product of claim 24, wherein the control data is based on one or more of location data, altitude data, velocity data, acceleration data, heading data, weather data, visibility data, and heart rate data.

28. The computer program product of claim 24, wherein the particular playback mode at each of the one or more instances is further determined based on user input.

29. The computer program product of claim 24, wherein the playing back the recorded information in the particular playback mode is further based on user control data received during playback.

30. The computer program product of claim 24, further comprising:
a computer readable program code configured to receive the recorded information and the control data from one or more external devices.

31. An apparatus, comprising:
means for receiving information for recording;
means for receiving sensor information in the apparatus;
means for determining control data based on the sensor information;
means for integrating one or more instances of control data with the corresponding instance of recorded information; and
means for storing the integrated information.

32. An apparatus, comprising:
means for activating an integrated information playback process in an apparatus, the integrated information comprising recorded information and control data;
means for processing one or more instances of the control data; and
means for playing back the recorded information in a particular playback mode, wherein the particular playback mode at one or more instances of the recorded information is determined in accordance with the processed control data occurring at the same instance.
